(19) United States
(12) Patent Application Publication
(10) Pub. No.: US 2026/0243117 A1
(43) Pub. Date: Aug. 20, 2026

(54) HANDLE DEVICE AND METHOD FOR INSTALLING HANDLE DEVICE

(71) Applicants: ALPHA CORPORATION, Kanagawa (JP); NISSAN MOTOR CO., LTD., Kanagawa (JP)

(72) Inventors: Saeko TATEMICHI, Kanagawa (JP); Ryoichi TANAKA, Kanagawa (JP); Kouji TSUJI, Kanagawa (JP)

(73) Assignees: ALPHA CORPORATION, Kanagawa (JP); NISSAN MOTOR CO., LTD., Kanagawa (JP)

(21) Appl. No.: 19/648,126

(22) Filed: Apr. 15, 2026

Related U.S. Application Data
(63) Continuation of application No. PCT/JP2024/036982, filed on Oct. 17, 2024.

(30) Foreign Application Priority Data
Oct. 18, 2023 (JP) 2023-179616

(51) Int. Cl. E05B 85/16; E05B 79/06; E05B 85/06

(52) U.S. Cl. CPC E05B 85/16; E05B 79/06; E05B 85/06

(57) ABSTRACT

A handle device includes: a handle base attached to an inside of a door panel of a vehicle; an operation handle including a first engagement portion engageable with one end side of the handle base and a second engagement portion engageable with the other end side of the handle base; a cylinder lock attached to the other end side of the handle base; and a cylinder cover attached to the cylinder lock from an outside of the door panel. The cylinder cover attached to the cylinder lock is covered with the operation handle. The operation handle is slid to the one end side of the handle base and the first engagement portion is engaged with the handle base, and movement of the operation handle to the other end side is restricted by the cylinder cover attached to the cylinder lock.

### CROSS-REFERENCE TO RELATED APPLICATIONS

This is a continuation of International Application No. PCT/JP2024/036982 filed on Oct. 17, 2024, and claims priority from Japanese Patent Application No. 2023-179616 filed on Oct. 18, 2023, the entire content of which is incorporated herein by reference.

### TECHNICAL FIELD

The present disclosure relates to a handle device and a method for installing a handle device.

### BACKGROUND ART

JP2016-030983A discloses a handle device in which a frame member installed to a door outer panel includes a bearing member, and a handle shaft portion provided on an engagement arm of a handle body is rotatably attached to the bearing member.

Incidentally, since the handle device described in JP2016-030983A has a structure in which the handle body is rotatably supported by the bearing member that is a member separate from the frame member, the number of components increases, and the cost increases. The handle body needs to be installed to the bearing member at a narrow place between an outer panel and an inner panel of a door, which results in poor installation workability.

The present disclosure provides a handle device and a method for installing a handle device with good installation while reducing cost.

### SUMMARY

According to the present disclosure, a handle device includes: a handle base attached to an inside of a door panel of a vehicle; an operation handle including a first engagement portion engageable with one end side of the handle base and a second engagement portion engageable with the other end side of the handle base, the operation handle being swingably supported by the handle base with an engagement location at the first engagement portion as a fulcrum; a cylinder lock attached to the other end side of the handle base; and a cylinder cover attached to the cylinder lock from an outside of the door panel. The cylinder cover attached to the cylinder lock is covered with the operation handle. The operation handle is slid to the one end side of the handle base and the first engagement portion is engaged with the handle base, and movement of the operation handle to the other end side is restricted by the cylinder cover attached to the cylinder lock.

The cylinder cover may include a protrusion portion configured to abut against the other end side of the handle base in the second engagement portion of the operation handle.

The cylinder cover may include a plurality of locking claws lockable to the cylinder lock.

The cylinder cover may have a thin plate shape insertable into a gap between the operation handle and the door panel generated in a state in which the operation handle is swung.

A dummy cylinder to which the cylinder cover is attachable may be attached to the handle base instead of the cylinder lock.

According to the present disclosure, a method for installing a handle device includes: attaching a handle base to an inside of a door panel of a vehicle; attaching a cylinder lock to the other end side of the handle base; engaging a first engagement portion on one end side of an operation handle with one end side of the handle base by sliding the operation handle to the one end side of the handle base; swinging and operating the operation handle with an engagement location at the first engagement portion as a fulcrum; and attaching a cylinder cover to the cylinder lock from a gap between the operation handle and the door panel formed by the swinging operation.

A dummy cylinder to which the cylinder cover is attachable may be attached to the handle base instead of the cylinder lock.

According to the present disclosure, a handle device and a method for installing a handle device with good installation while reducing cost can be provided.

### BRIEF DESCRIPTION OF DRAWINGS

FIG. 1 is a front view of a handle device according to an embodiment;

FIG. 2 is an exploded perspective view of the handle device;

FIG. 3 is a perspective view of a cylinder cover;

FIG. 4 is a perspective view of the cylinder cover as viewed from a back side;

FIG. 5 is a perspective view of a cylinder lock and the cylinder cover;

FIG. 6 is a perspective view of the cylinder lock attached with the cylinder cover as viewed from a back side;

FIG. 7A is a cross-sectional view taken along a horizontal direction of a door panel at an attachment position of the handle device, for illustrating an installation procedure of the handle device;

FIG. 7B is a cross-sectional view taken along the horizontal direction of the door panel at the attachment position of the handle device, for illustrating the installation procedure of the handle device;

FIG. 7C is a cross-sectional view taken along the horizontal direction of the door panel at the attachment position of the handle device, for illustrating the installation procedure of the handle device;

FIG. 7D is a cross-sectional view taken along the horizontal direction of the door panel at the attachment position of the handle device, for illustrating the installation procedure of the handle device;

FIG. 7E is a cross-sectional view taken along the horizontal direction of the door panel at the attachment position of the handle device, for illustrating the installation procedure of the handle device;

FIG. 8A is a cross-sectional view along an up-down direction of the door panel at an attachment location of the cylinder lock, for illustrating an attachment procedure of the cylinder cover; and

FIG. 8B is a cross-sectional view along the up-down direction of the door panel at the attachment location of the cylinder lock, for illustrating the attachment procedure of the cylinder cover.

### DESCRIPTION OF EMBODIMENTS

Hereinafter, an example of an embodiment of the present disclosure will be described with reference to the drawings. In the following drawings, an arrow FR indicates a vehicle front side, an arrow BC indicates a vehicle rear side, an arrow UP indicates a vehicle upper side, an arrow DW indicates a vehicle lower side, an arrow WR indicates a vehicle right side, and an arrow WL indicates a vehicle left side.

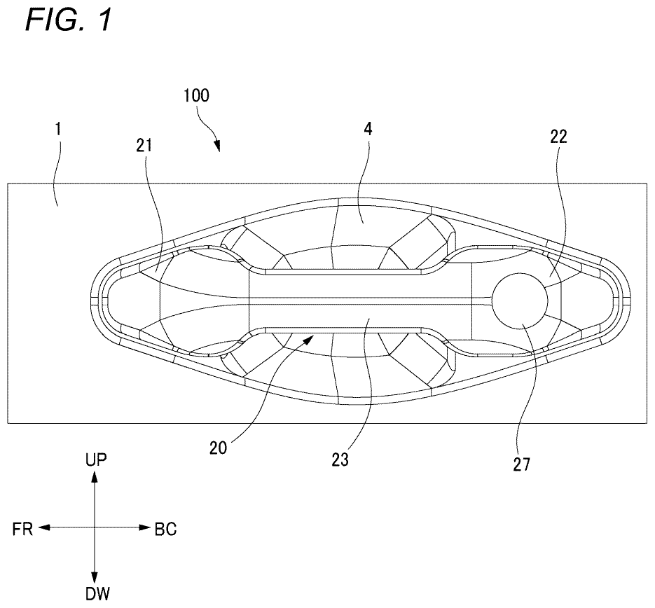

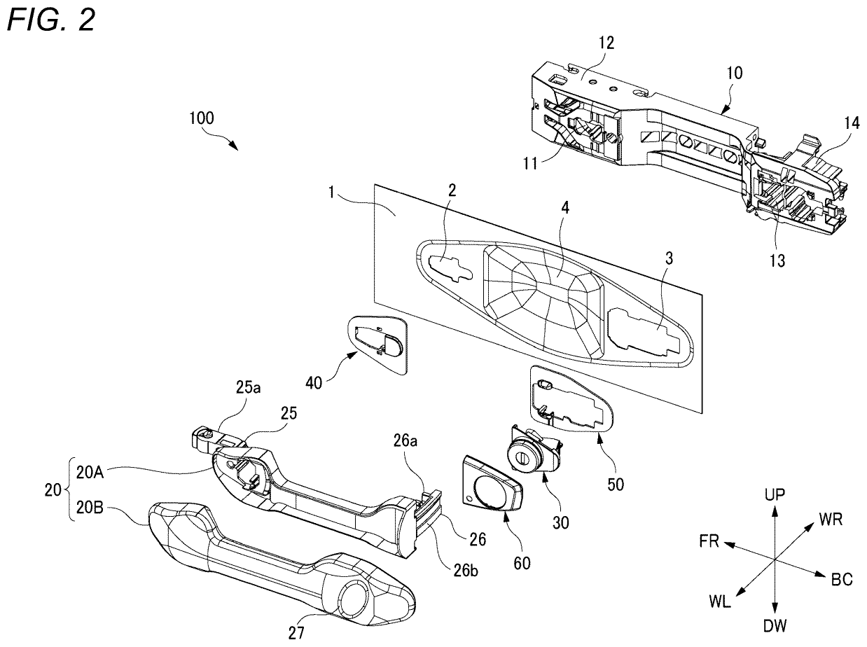

FIG. 1 is a front view of a handle device 100 according to the present embodiment. FIG. 2 is an exploded perspective view of the handle device 100.

As illustrated in FIGS. 1 and 2, the handle device 100 according to the present embodiment is installed to a door panel 1 of a vehicle. In this example, the handle device 100 provided on a left door of the vehicle will be described as an example.

The door panel 1 is an outer panel constituting a door of the vehicle. The handle device 100 includes a handle base 10, an operation handle 20, and a cylinder lock 30. The handle device 100 further includes a first gasket 40, a second gasket 50, and a cylinder cover 60.

The door panel 1 to which the handle device 100 is installed has a first opening portion 2 and a second opening portion 3. The first opening portion 2 and the second opening portion 3 are attachment holes for attaching the handle device 100 to the door panel 1. The first opening portion 2 is formed on the vehicle front side FR, and the second opening portion 3 is formed on the vehicle rear side BC. In the door panel 1, a recessed portion 4 into which a hand of an operator enters when operating the handle device 100 is formed between the first opening portion 2 and the second opening portion 3. The recessed portion 4 has a recessed shape recessed toward an inside of the door panel 1.

The handle base 10 is fixed on the inside the door panel 1. The handle base 10 includes a first support portion 12 having a first support hole 11 and a second support portion 14 having a second support hole 13. By attaching the handle base 10 to the door panel 1 from the inside, the first support hole 11 in the first support portion 12 communicates with the first opening portion 2 in the door panel 1, and the second support hole 13 in the second support portion 14 communicates with the second opening portion 3.

The operation handle 20 is installed to the handle base 10 attached to the door panel 1 from an outside of the door panel 1 and supported by the handle base 10. The operation handle 20 is formed in a rod shape. The operation handle 20 includes a grip body portion 20A and a grip cover 20B installed to cover an outside of the grip body portion 20A.

The grip body portion 20A is provided with a first engagement portion 25 on one end side, and is provided with a second engagement portion 26 on the other end side. In the operation handle 20 in which the grip cover 20B is installed to the grip body portion 20A, the one end side of the grip body portion 20A, which includes the first engagement portion 25, is a first attachment portion 21, and the other end side of the grip body portion 20A, which includes the second engagement portion 26, is a second attachment portion 22. In the operation handle 20, a grip portion 23 is provided between the first attachment portion 21 and the second attachment portion 22. The operation handle 20 is installed to the handle base 10 attached to the door panel 1 such that one end on a first attachment portion 21 side faces the vehicle front side FR and the other end on a second attachment portion 22 side faces the vehicle rear side BC.

In the operation handle 20, the first engagement portion 25 and the second engagement portion 26 of the grip body portion 20A protrude in an installation direction to the handle base 10. The first engagement portion 25 and the second engagement portion 26 include engagement claws 25a and 26a protruding toward the vehicle front side FR, respectively. The second engagement portion 26 includes an extension portion 26b extending in the installation direction to the handle base 10, and the engagement claw 26a is formed at a tip portion of the extension portion 26b.

The first engagement portion 25 of the operation handle 20 is inserted into the first support hole 11 in the first support portion 12 of the handle base 10, and the engagement claw 25a is engaged with the vehicle front side FR of the first engagement portion 25. The second engagement portion 26 of the operation handle 20 is inserted into the second support hole 13 in the second support portion 14 of the handle base 10, and the engagement claw 26a is engaged with the vehicle front side FR of the second engagement portion 26. The operation handle 20 is supported to be swingable with respect to the handle base 10 with an engagement location of the first engagement portion 25 in the first support portion 12 of the handle base 10 as a fulcrum. The operation handle 20 has a key hole portion 27 on the other end side, and the cylinder lock 30 can be operated by a key inserted into the key hole portion 27.

The cylinder lock 30 is fixed to the second support portion 14 of the handle base 10 fixed to the door panel 1. The cylinder lock 30 is screwed and fixed in a state of being fitted into the second support hole 13 in the second support portion 14 from the outside of the door panel 1. The cylinder lock 30 is disposed on the vehicle rear side BC relative to an insertion location of the second engagement portion 26 of the operation handle 20 in the second support hole 13.

The first gasket 40 and the second gasket 50 are attached to the door panel 1. The first gasket 40 and the second gasket 50 are formed of, for example, an elastic resin material such as polypropylene or synthetic rubber. The first gasket 40 is formed in an annular shape along an edge portion of the first opening portion 2 in the door panel 1, and is attached to the door panel 1 along the edge portion of the first opening portion 2. The first gasket 40 is disposed between the first attachment portion 21 of the operation handle 20 installed to the handle base 10 and the door panel 1. The second gasket 50 is formed in an annular shape along an edge portion of the second opening portion 3 in the door panel 1, and is attached to the door panel 1 along the edge portion of the second opening portion 3. The second gasket 50 is disposed between the second attachment portion 22 of the operation handle 20 installed to the handle base 10 and the door panel 1.

The cylinder cover 60 is attached to the cylinder lock 30 from the outside of the door panel 1. The cylinder cover 60 is formed of, for example, a synthetic resin such as plastic. The cylinder cover 60 is attached to cover periphery of the cylinder lock 30. The cylinder cover 60 and the cylinder lock 30 is covered on an outside by the second attachment portion 22 of the operation handle 20. That is, the handle device 100 is a seamless type in which an escutcheon portion in which the cylinder lock 30 is overlapped and covered with the operation handle 20 is integrally provided.

In the handle device 100 having the structure described above, the operation handle 20 is swingable with the engagement location of the first engagement portion 25 with the first support portion 12 of the handle base 10 as the fulcrum. Accordingly, the operation handle 20 is swung between an initial position (a position in FIG. 1) along the door panel 1 and an operation position at which a rear end is separated from the door panel 1. That is, in the handle device 100, when the grip portion 23 of the operation handle 20 is gripped and pulled to a near side, the operation handle 20 swings from the initial position to the operation position with the engagement location of the first engagement portion 25 with the first support portion 12 as the fulcrum. When the operation handle 20 is released, the operation handle 20 swings from the operation position to the initial position by an internal biasing unit (not illustrated) with the engagement location of the first engagement portion 25 with the first support portion 12 of the handle base 10 as the fulcrum. In the handle device 100, when the operation handle 20 is pulled to the near side and swings to the operation position, a latch (not illustrated) of a door device is operated to open the door.

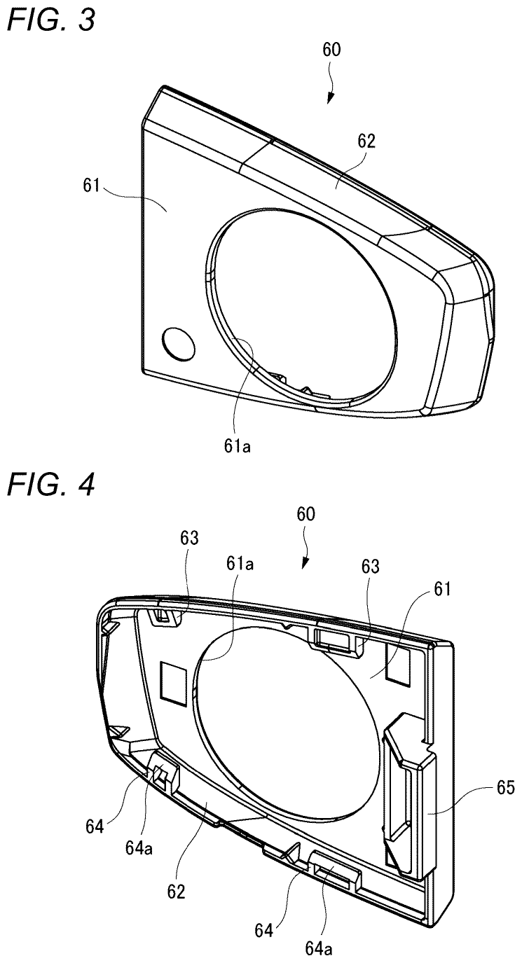

FIG. 3 is a perspective view of the cylinder cover 60. FIG. 4 is a perspective view of the cylinder cover 60 as viewed from a back side.

As illustrated in FIGS. 3 and 4, the cylinder cover 60 includes a flat plate portion 61 and a peripheral wall portion 62 around the flat plate portion 61. A circular hole portion 61a is formed in the flat plate portion 61. The peripheral wall portion 62 is formed to rise from a peripheral edge of the flat plate portion 61 in an attachment direction to the cylinder lock 30. The cylinder cover 60 includes pairs of locking claws 63 and 64 at upper and lower positions thereof. The upper and lower locking claws 63 and 64 are disposed at positions facing each other. The locking claw 63 on an upper side is formed to protrude downward from an edge portion of the peripheral wall portion 62, and the locking claw 64 on a lower side is formed to protrude upward from the edge portion of the peripheral wall portion 62. The locking claw 64 on the lower side has a guide surface 64a gradually inclined toward the flat plate portion 61 in a protruding direction on a surface opposite to the flat plate portion 61. The cylinder cover 60 includes a protrusion portion 65 protruding outward from the peripheral wall portion 62.

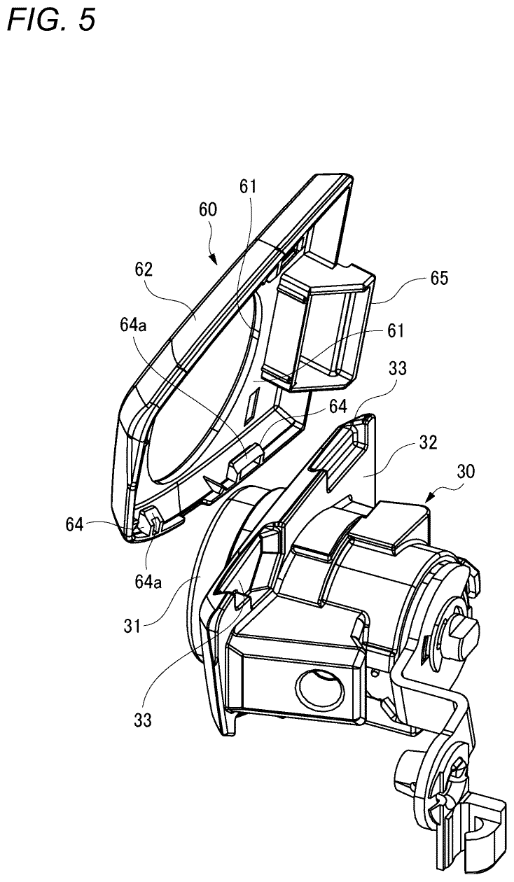

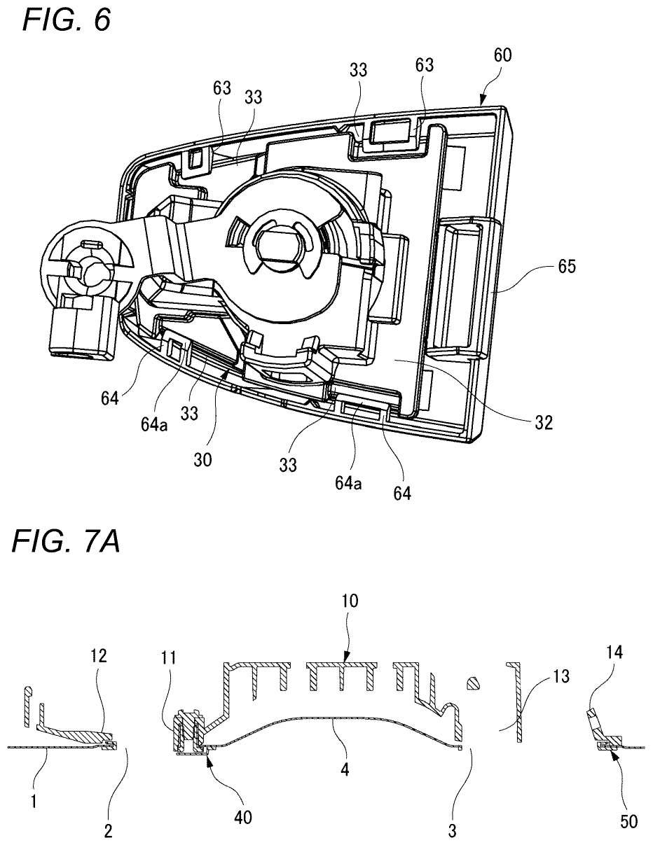

FIG. 5 is a perspective view of the cylinder lock 30 and the cylinder cover 60. FIG. 6 is a perspective view of the cylinder lock 30 to which the cylinder cover 60 is attached as viewed from the back side.

As illustrated in FIGS. 5 and 6, the cylinder lock 30 to which the cylinder cover 60 is attached includes a cylinder portion 31 into which the key is inserted and which is rotationally operated, and a flange portion 32 protruding around the cylinder portion 31. The cylinder portion 31 is formed in a circular shape, and a part thereof protrudes from the flange portion 32 to a front side. Locking recesses 33 are formed on upper and lower sides of the flange portion 32.

When the cylinder cover 60 is attached to the cylinder lock 30, a front surface side of the flange portion 32 of the cylinder lock 30 is covered by the flat plate portion 61, and periphery of the flange portion 32 is covered by the peripheral wall portion 62. In this state, the cylinder portion 31 of the cylinder lock 30 is fitted into the hole portion 61a in the flat plate portion 61 of the cylinder cover 60. In this way, when the cylinder cover 60 is attached to the cylinder lock 30, the locking claws 63 and 64 of the cylinder cover 60 locks the locking recesses 33 formed on the flange portion 32 of the cylinder lock 30. Accordingly, the cylinder cover 60 is fixed to the cylinder lock 30.

By attaching the cylinder cover 60, movement of the operation handle 20 toward the vehicle rear side BC, which is a side opposite to an engagement direction with the handle base 10 of the second support portion 14, is restricted by the cylinder cover 60. When the operation handle 20 is rotationally operated, the second engagement portion 26 of the operation handle 20 abuts against the protrusion portion 65 of the cylinder cover 60, whereby movement of the second engagement portion 26 of the operation handle 20 toward the vehicle rear side BC, which is a side opposite to an engagement direction with the handle base 10, is restricted, and the operation handle 20 is prevented from coming off. Instead of the cylinder lock 30, a dummy cylinder formed of a resin and having substantially the same outer shape as the cylinder lock 30 may be attached to the handle base 10, and the cylinder cover 60 may be attached to the dummy cylinder. Also in this case, the movement of the operation handle 20 toward the vehicle rear side BC can be restricted by the cylinder cover 60 attached to the dummy cylinder.

Next, a case in which the handle device 100 is installed to the door panel 1 will be described.

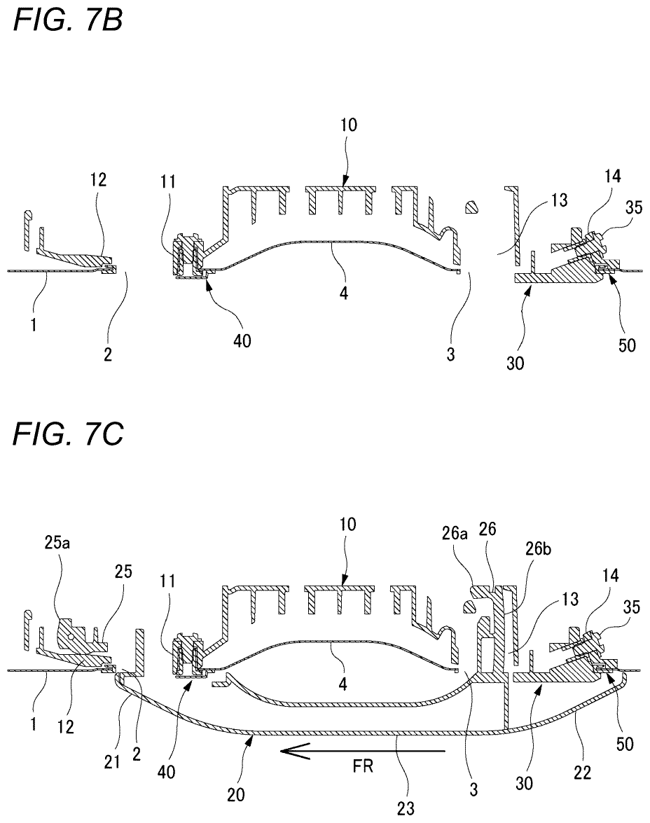

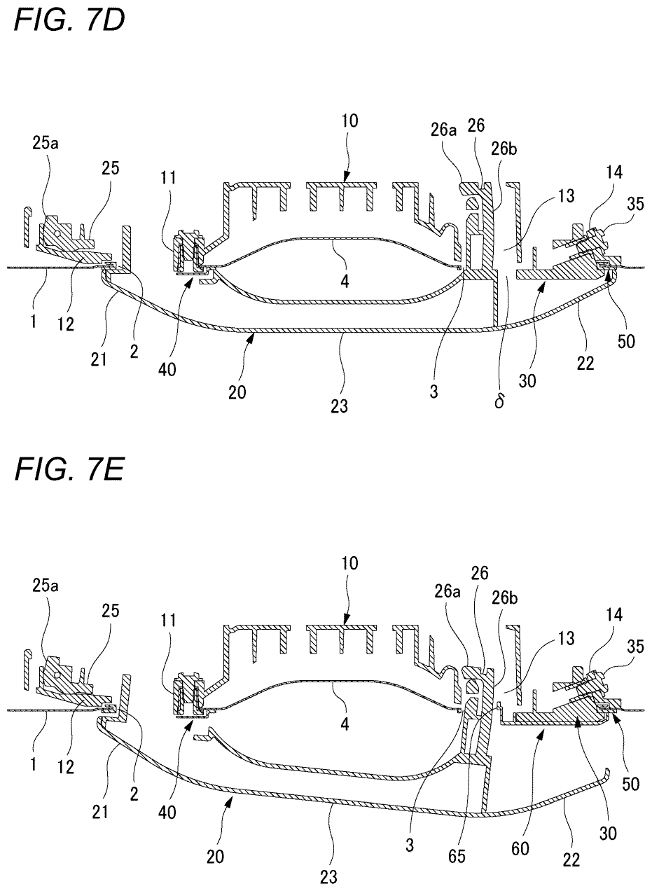

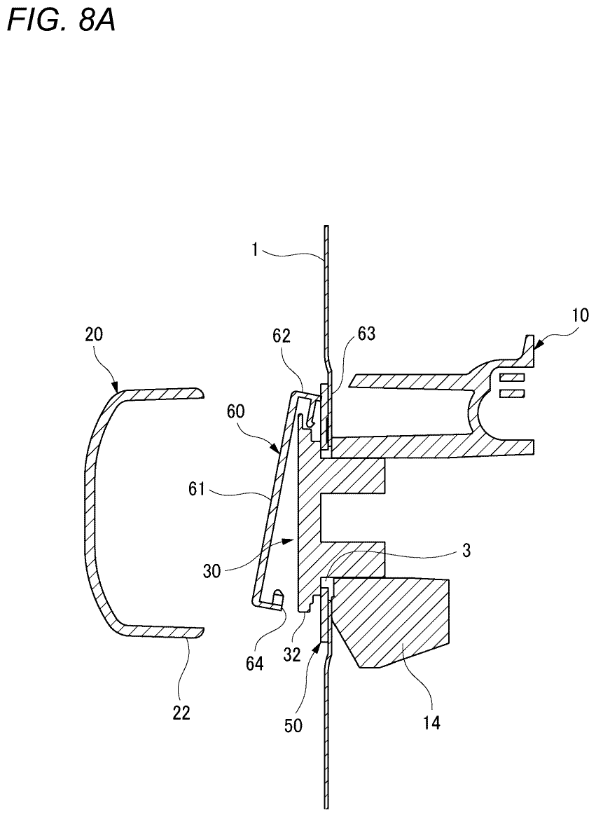

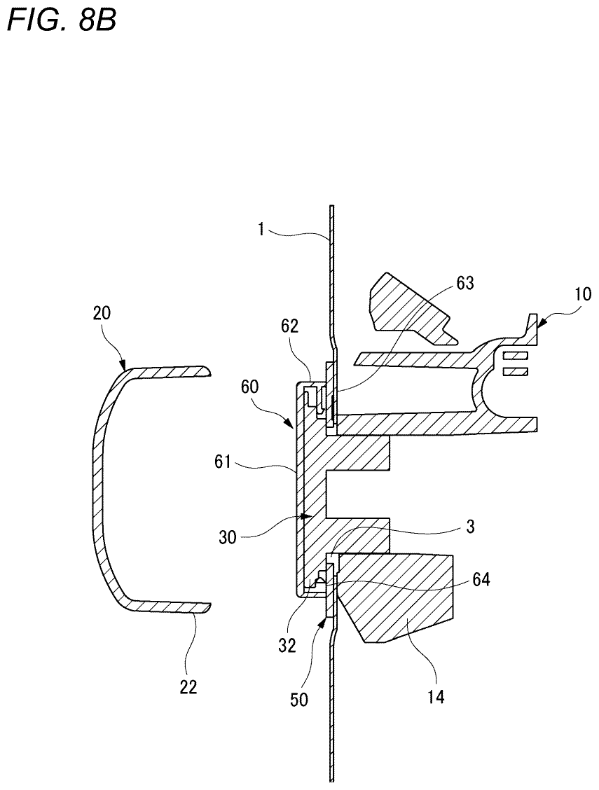

FIGS. 7A to 7E are cross-sectional views taken along a horizontal direction of the door panel 1 at the attachment position of the handle device 100, for illustrating an installation procedure of the handle device 100. FIGS. 8A and 8B are cross-sectional views taken along an up-down direction of the door panel 1 at an attachment location of the cylinder lock 30, for illustrating an attachment procedure of the cylinder cover 60.

As illustrated in FIG. 7A, the handle base 10 is attached from the inside of the door panel 1. Specifically, a claw (not illustrated) provided on the first support portion 12 of the handle base 10 is installed to the first opening portion 2 in the door panel 1, and a claw (not illustrated) provided on the second support portion 14 of the handle base 10 is installed to the second opening portion 3. Then, the first support hole 11 in the first support portion 12 of the handle base 10 communicates with the first opening portion 2 in the door panel 1, and the second support hole 13 in the second support portion 14 of the handle base 10 communicates with the second opening portion 3 in the door panel 1. The first gasket 40 and the second gasket 50 are attached from the outside of the door panel 1.

As illustrated in FIG. 7B, the cylinder lock 30 is fitted into the second support hole 13 in the second support portion 14 of the handle base 10 from the outside of the door panel 1, and the cylinder lock 30 is fixed to the handle base 10 from the inside of the door panel 1 by a screw 35.

As illustrated in FIG. 7C, the operation handle 20 is installed from the outside of the door panel 1. Specifically, the first engagement portion 25 of the operation handle 20 is inserted into the first support hole 11 in the first support portion 12 of the handle base 10, and the second engagement portion 26 of the operation handle 20 is inserted into the second support hole 13 in the second support portion 14 of the handle base 10. The second engagement portion 26 is inserted into the cylinder lock 30 in the second support hole 13 on the vehicle front side FR. When the first engagement portion 25 and the second engagement portion 26 are inserted into the first support hole 11 and the second support hole 13, respectively, as illustrated in FIG. 7D, the operation handle 20 is slid toward the vehicle front side FR. Accordingly, the engagement claw 25a of the first engagement portion 25 is engaged with the first support portion 12 of the handle base 10. The engagement claw 26a of the second engagement portion 26 is engaged with a lever (not illustrated) rotatably held by the second support portion 14.

By sliding the operation handle 20 toward the vehicle front side FR, a gap δ is formed between the second engagement portion 26 and the cylinder lock 30.

As illustrated in FIG. 7E, the operation handle 20 is pulled to the near side and rotated, a gap is formed between the second attachment portion 22 and the door panel 1, and the cylinder cover 60 is attached to the cylinder lock 30 from the outside of the door panel 1.

To attach the cylinder cover 60, first, as illustrated in FIG. 8A, the locking claws 63 on the upper side of the cylinder cover 60 are locked to the locking recesses 33 on the upper side of the flange portion 32 of the cylinder lock 30. Next, a lower portion of the cylinder cover 60 is pushed toward the cylinder lock 30, and as illustrated in FIG. 8B, the locking claws 64 on the lower side of the cylinder cover 60 are locked to the locking recesses 33 on the lower side of the flange portion 32 of the cylinder lock 30.

In this way, after the locking claws 63 on the upper side of the cylinder cover 60 are locked to the flange portion 32 of the cylinder lock 30, the locking claws 64 on the lower side are locked to the flange portion 32 of the cylinder lock 30. Therefore, the cylinder cover 60 can be easily attached to the cylinder lock 30 in the gap between the second attachment portion 22 of the operation handle 20 and the door panel 1 without the cylinder cover 60 falling off. When the cylinder cover 60 is attached to the cylinder lock 30, the locking claw 64 is easily elastically deformed by the guide surface 64a gradually inclined toward the flat plate portion 61 in the protruding direction coming into contact with the flange portion 32 of the cylinder lock 30. Therefore, the locking claw 64 can be easily inserted into the locking recess 33 on the back side of the flange portion 32 by riding over the flange portion 32. Since the cylinder cover 60 includes the plurality of locking claws 63 and 64 that can be locked to the cylinder lock 30, the cylinder cover 60 can be easily attached to the cylinder lock 30 by locking the locking claws 63 and 64 to the cylinder lock 30.

When the cylinder cover 60 is attached to the cylinder lock 30, the front surface side of the flange portion 32 of the cylinder lock 30 is covered by the flat plate portion 61, and the periphery of the flange portion 32 is covered by the peripheral wall portion 62. In this state, the cylinder portion 31 of the cylinder lock 30 is fitted into the hole portion 61a in the flat plate portion 61 of the cylinder cover 60.

In this way, when the cylinder cover 60 is attached to the cylinder lock 30, the gap δ is filled by the protrusion portion 65 provided on the vehicle front side FR of the cylinder cover 60, and therefore, the cylinder cover 60 restricts the movement of the operation handle 20 toward the rear side, which is a side opposite to the engagement direction with the handle base 10 of the second support portion 14. That is, the movement of the operation handle 20 toward the vehicle rear side BC is restricted. Accordingly, the operation handle 20 is prevented from coming off from the handle base 10.

As described above, according to the handle device 100 of the present embodiment, the cylinder cover 60 attached to the cylinder lock 30 has a function of preventing the operation handle 20 from coming off from the handle base 10. Therefore, even in an escutcheon-integrated sleeve-less type in which the cylinder lock 30 is overlapped and covered with the operation handle 20, by engaging the operation handle 20 with the handle base 10 and attaching the cylinder cover 60 to the cylinder lock 30, the operation handle 20 can be easily prevented from coming off, and installation workability can be improved while reducing the cost.

The cylinder cover 60 includes the protrusion portion 65 with which the second engagement portion 26 of the operation handle 20 can abut on the vehicle rear side BC, which is a side opposite to the engagement direction with the handle base 10. Therefore, when the second engagement portion 26 of the operation handle 20 abuts against the protrusion portion 65 of the cylinder cover 60, the movement of the second engagement portion 26 of the operation handle 20 on a side opposite to the engagement direction with the handle base 10 is restricted, and an effect of preventing the operation handle 20 from coming off is enhanced.

The present disclosure is not limited to the embodiment described above, and modifications, improvements, and the like can be made as appropriate. In addition, materials, shapes, dimensions, numbers, arrangement locations, and the like of each component in the embodiment described above are optional and are not limited as long as the present disclosure can be achieved.

The handle device according to the present disclosure includes:
a handle base (10) attached to an inside of a door panel (1) of a vehicle;
an operation handle (20) including a first engagement portion (25) engageable with one end side of the handle base (10) and a second engagement portion (26) engageable with the other end side of the handle base (10), the operation handle (20) being swingably supported by the handle base (10) with an engagement location at the first engagement portion (25) as a fulcrum;
a cylinder lock (30) attached to the other end side of the handle base (10); and
a cylinder cover (60) attached to the cylinder lock (30) from an outside of the door panel (1), in which
the cylinder cover (60) attached to the cylinder lock (30) is covered with the operation handle (20), and
the operation handle (20) is slid to the one end side of the handle base (10) and the first engagement portion (25) is engaged with the handle base (10), and movement of the operation handle (20) to the other end side is restricted by the cylinder cover (60) attached to the cylinder lock (30).

According to the handle device having this configuration, the cylinder cover attached to the cylinder lock has a function of preventing the operation handle from coming off from the handle base. Therefore, even in an escutcheon-integrated type in which the cylinder lock is overlapped and covered with the operation handle, by engaging the operation handle with the handle base and attaching the cylinder cover to the cylinder lock, the operation handle can be easily prevented from coming off, and installation workability can be improved while reducing the cost.

The cylinder cover (60) may include a protrusion portion (65) configured to abut against the other end portion of the handle base (10) in the second engagement portion (26) of the operation handle (20).

According to the handle device having this configuration, the second engagement portion of the operation handle abuts against the protrusion portion of the cylinder cover, whereby movement of the second engagement portion toward a side opposite to an engagement direction with the handle base is restricted, and the operation handle is prevented from coming off.

The cylinder cover (60) may include a plurality of locking claws (63 and 64) lockable to the cylinder lock (30).

According to the handle device having this configuration, the cylinder cover can be easily attached to the cylinder lock by locking the locking claws to the cylinder lock.

The cylinder cover (60) may have a thin plate shape insertable into a gap between the operation handle (20) and the door panel (1) generated in a state in which the operation handle (20) is swung.

According to the handle device having this configuration, the cylinder cover can be easily inserted into the gap between the operation handle and the door panel generated in the state in which the operation handle is swung, and can be attached to the cylinder lock.

A dummy cylinder to which the cylinder cover (60) is attachable may be attached to the handle base (10) instead of the cylinder lock (30).

According to the handle device having this configuration, the cylinder cover can be attached to the dummy cylinder attached to the handle base.

A method for installing a handle device according to the present disclosure includes: attaching a handle base (10) to an inside of a door panel (1) of a vehicle; attaching a cylinder lock (30) to the other end side of the handle base (10);
engaging a first engagement portion (25) on one end side of an operation handle (20) with one end side of the handle base (10) by sliding the operation handle (20) to the one end side of the handle base (10);
swinging and operating the operation handle (20) with an engagement location at the first engagement portion (25) as a fulcrum; and
attaching a cylinder cover (60) to the cylinder lock (30) from a gap between the operation handle (20) and the door panel (1) formed by the swinging operation.

According to the method for installing a handle device, even in an escutcheon—integrated type in which the cylinder lock is overlapped and covered with the operation handle, the cylinder cover can be attached to the cylinder lock from the gap between the operation handle and the door panel formed by swinging and operating the operation handle engaged with the handle base, and the operation handle can be easily prevented from coming off.

A dummy cylinder to which the cylinder cover (60) is attachable may be attached to the handle base (10) instead of the cylinder lock (30).

According to the method for installing a handle device, the cylinder cover can be attached to the dummy cylinder attached to the handle base.

Although various embodiments have been described above, it is needless to say that the present disclosure is not limited to such embodiments. It is apparent to those skilled in the art that various variations or modifications can be conceived within the scope described in the claims, and it is understood that the variations or modifications naturally fall within the technical scope of the present disclosure. The components described in the embodiment described above may be freely combined without departing from the spirit of the disclosure.

What is claimed is:

1. A handle device comprising:
a handle base attached to an inside of a door panel of a vehicle;
an operation handle including a first engagement portion engageable with one end side of the handle base and a second engagement portion engageable with the other end side of the handle base, the operation handle being swingably supported by the handle base with an engagement location at the first engagement portion as a fulcrum;
a cylinder lock attached to the other end side of the handle base; and
a cylinder cover attached to the cylinder lock from an outside of the door panel,
wherein the cylinder cover attached to the cylinder lock is covered with the operation handle, and
wherein the operation handle is slid to the one end side of the handle base and the first engagement portion is engaged with the handle base, and movement of the operation handle to the other end side is restricted by the cylinder cover attached to the cylinder lock.

2. The handle device according to claim 1,
wherein the cylinder cover includes a protrusion portion configured to abut against the other end side of the handle base in the second engagement portion of the operation handle.

3. The handle device according to claim 1,
wherein the cylinder cover includes a plurality of locking claws lockable to the cylinder lock.

4. The handle device according to claim 1,
wherein the cylinder cover has a thin plate shape insertable into a gap between the operation handle and the door panel generated in a state in which the operation handle is swung.

5. The handle device according to claim 1,
wherein a dummy cylinder to which the cylinder cover is attachable is attached to the handle base instead of the cylinder lock.

6. A method for installing a handle device, the method comprising:
attaching a handle base to an inside of a door panel of a vehicle;
attaching a cylinder lock to the other end side of the handle base;
engaging a first engagement portion on one end side of an operation handle with one end side of the handle base by sliding the operation handle to the one end side of the handle base;
swinging and operating the operation handle with an engagement location at the first engagement portion as a fulcrum; and
attaching a cylinder cover to the cylinder lock from a gap between the operation handle and the door panel formed by the swinging operation.

7. The method for installing a handle device according to claim 6,
wherein a dummy cylinder to which the cylinder cover is attachable is attached to the handle base instead of the cylinder lock.
